(19) United States
(12) Patent Application Publication
(10) Pub. No.: US 2025/0367910 A1
(43) Pub. Date: Dec. 4, 2025

(54) LAMINATES BASED ON COPOLYMERS OF DIISOALKENYLARENES

(71) Applicant: Notark Corporation, The Woodlands, TX (US)

(72) Inventors: Vijay MHETAR, Houston, TX (US); Jason Tian, Houston, TX (US)

(73) Assignee: Notark Corporation, The Woodlands, TX (US)

(21) Appl. No.: 19/223,108

(22) Filed: May 30, 2025

Related U.S. Application Data
(60) Provisional application No. 63/654,134, filed on May 31, 2024.

(51) Int. Cl. B32B 15/082; B32B 7/12; B32B 15/20; B32B 17/04

(52) U.S. Cl. CPC B32B 15/082; B32B 7/12; B32B 15/20; B32B 17/04; B32B 2250/05; B32B 2250/40; B32B 2260/021; B32B 2260/046; B32B 2262/101; B32B 2264/1021; B32B 2270/00; B32B 2305/076; B32B 2305/72; B32B 2307/204; B32B 2307/206; B32B 2307/306; B32B 2307/40; B32B 2307/734; B32B 2307/7376; B32B 2311/12; B32B 2325/00; B32B 2355/00; B32B 2363/00

(57) ABSTRACT

The disclosure relates to a multi-layered laminate comprising multiple metal foil layers and multiple dielectric (insulating) layers. At least one of the insulating layers includes a copolymer containing diisoalkenylarene (DIAEA) and divinylarene (DVA) units, optionally combined with a filler and/or another dielectric polymer. Another insulating layer includes another dielectric polymer distinct from the DIAEA-DVA copolymer. At least one copolymer-containing insulating layer is positioned adjacent to a metal foil layer. This copolymer layer enhances thermal stability at elevated temperatures and provides improved electrical performance such as reduced dielectric constant (Dk) and dissipation factor (Df) along with excellent processability.

### RELATED APPLICATIONS

This application claims priority from U.S. Provisional Application No. 63/654,134 with a filing date of May 31, 2024, the disclosure of which is incorporated herein by reference.

### FIELD

The disclosure relates to a multi-layered laminate comprising a copolymer layer of a diisoalkenylarene copolymer for use in copper clad laminate applications.

### BACKGROUND

Circuit boards play a crucial role in the production of compact electronic devices. There is a growing need for high-frequency and heat-resistant circuit boards to meet current and future technological demands. These high-performance circuit boards consist of multiple layers, each with specific requirements, such as low dielectric constants (Dk), minimal dissipation factors (Df), low coefficients of thermal expansion (CTE), strong adhesion to various substrates, and low water absorption.

To enhance the performance of circuit boards, one or more layers must be positioned adjacent to a metal foil. The incorporation of a cross-linkable copolymer offers several advantages, including high heat resistance, as well as desirable properties like low dielectric constants (Dk) and minimal dissipation factors (Df). These copolymers can be tailored with reactive functional groups such as vinyl or epoxy, promoting increased cross-linking density during curing. The cross-linkable copolymer is typically incorporated into one or more insulating layers.

There is still a need for copper clad laminates (CCL) with improved performance for enhanced electrical and mechanical properties.

### SUMMARY

In one aspect, the disclosure relates to a laminate comprising, consisting essentially of, or consists of a first metal foil, a first insulating layer, and a second insulating layer. The first insulating layer which has a thickness of 3-20 μm and a Dk of <2.8, a Df <0.002 is positioned between the first metal foil and the second insulating layer and includes 40 to 70 weight percent of a copolymer of a diisoalkenylarene and a divinylarene, where the copolymer has a mole ratio of diisoalkenylarene to divinylarene ranging from 15:1 to 1:15. The first insulating layer may further include 30 to 60 weight percent of a filler and 0 to 20 weight percent of other dielectric polymer. The second insulating layer having thickness of 60-150 μm, greater than the thickness of first insulating layer, Dk of <5.0 and a Df<0.05, the second insulating layer comprises, 30-60 wt. % of a glass fiber, 0-30 wt. % of a filler, and 20-50 wt. % of another dielectric polymer. The amounts of glass fiber, filler and another dielectric polymer are independently selected within the specified ranges such that the total is 100 wt. %. The laminate has a Dk of <5, Df of <0.01, measured at 10 GHz, in accordance with ASTM D2520

In a second aspect, the laminate further comprising a third insulating layer disposed on the second insulating layer, the third insulating layer having the same composition as the first insulating layer, and a second metal foil disposed on the third insulating layer. The second insulating layer is disposed between the first and third insulating layers.

In a third aspect, the laminate further comprising the second metal foil, wherein the second insulating layer is positioned between the first insulating layer and the second metal foil.

### DESCRIPTION OF THE DRAWINGS

FIG. 1 is a cross-sectional view of a multilayered laminate structure comprising first and second metal foils, two outer dielectric layers containing a cross-linkable copolymer, and a central insulating layer comprising glass fiber and another dielectric polymer.

FIG. 2 is a cross-sectional view of a multilayered laminate structure similar to FIG. 1, with the difference being that the two outer dielectric layers contain both a cross-linkable copolymer and another dielectric polymer.

FIG. 3 is a cross-sectional view of a four-layer laminate structure comprising two outer metal foils, a first insulating layer containing a cross-linkable copolymer, and a second insulating layer comprising glass fiber and another dielectric polymer.

FIG. 4 is a cross-sectional view of a multilayered laminate structure similar to FIG. 3, with the difference being that in addition to the cross-linkable copolymer, the first insulating layer also contains another dielectric polymer.

FIG. 5 is a schematic process flow diagram illustrating a method to construct the laminate structures described in FIGS. 1-4.

### DESCRIPTION

The following terms will be used throughout the specification:

“At least one of [a group such as A, B, and C]” or “any of [a group such as A, B, or C]” means a single member from the group, more than one member from the group, or a combination of members from the group. For example, at least one of A, B, and C includes, for example, A only, B only, or C only, as well as A and B, A and C, B and C; or A, B, and C, or any other all combinations of A, B, and C.

A list of embodiments presented as “A, B, or C” is to be interpreted as including the embodiments, A only, B only, C only, “A or B,” “A or C,” “B or C,” or “A, B, or C.”

“Any of A, B, or C” refers to one option from A, B, or C.

“Any of A, B, and C” refers to one or more options from A, B, and C.

“Cured” or “cross-linked” used interchangeably and refers to the formation of covalent bonds that link one polymer chain to another or link one polymerized repeating unit to another in the same polymer chain thereby altering the properties of the material.

“Molecular weight” or M_{w} refers to the polystyrene equivalent molecular weight in g/mol of a polymer block or a block copolymer. M_{w} can be measured with gel permeation chromatography (GPC) using polystyrene calibration standards, such as is done according to ASTM 5296. The GPC detector can be an ultraviolet or refractive index detector or a combination thereof. The chromatograph is calibrated using commercially available polystyrene molecular weight standards. M_{w} of polymers measured using GPC so calibrated are polystyrene equivalent molecular weights or apparent molecular weights. M_{w} expressed herein is measured at the peak of the GPC trace and are commonly referred to as polystyrene equivalent “peak molecular weight,” designated as Mₚ.

“Substantially Gel-Free” refers to a polymer containing <10, or <8, or <5, or <3, or <2, or <1 wt. % of a solid matter insoluble in a hydrocarbon solvent, e.g., toluene, cyclohexane, methyl-ethyl ketone (MEK), xylene, etc., or a mixture of hydrocarbon solvents.

“Gel Content” refers to the insoluble contents of a cured polymer composition in toluene as a percentage of the cured polymer composition (prior to immersing in the toluene). In embodiments, the Gel Content is >90 wt. % (toluene extractable of <10 wt. %), or >95 wt. % (toluene extractable of <5 wt. %), or >98 wt. % (toluene extractable of <2 wt. %).

“Gel Content Test” refers to a measurement of a Gel Content by placing a sample of a cured polymer composition having a weight G1 in 20 times volume of toluene, for a period of 4 hours at room temperature. Content in toluene is then filtered to recover the solid portion of the cured polymer composition, then dried to fully remove the solvent, and weighed, giving the insoluble content G2. Gel Content is calculated as (G2/G1). In embodiments, the Gel Content is measured by soaking the sample of the cured polymer composition at 90° C. for 9 hours followed by filtration to obtain solids, drying the solids, and recording weight.

“Solubility Test” refers to a measurement of a solubility by placing a polymer/copolymer sample in about 10 times volume of a hydrocarbon solvent, e.g., toluene, shake well and leave up to 4 hours at room temperature. Afterwards, examine the polymer/copolymer in the solvent by visual observation whether it has dissolved completely or partially. Decant or filter the content to measure weight of the remaining polymer/copolymer, after drying, to calculate weight of the dissolved polymer/copolymer.

“Swelling Content” refers to a weight difference (W %) of a weight of a cured polymer composition after being immersed in toluene until fully saturated, i.e., the sample weight (W2) remains the same after a period of time, not soaking any more toluene, and the weight of the curable polymer composition before immersion (W1), calculated as:

$$W \% = ( W 2 - W 1 ) / W 1 * 100$$

Df indicates “Dissipation Factor” or “loss tangent” (Df) and is a measure of loss rate of electrical energy in a dissipative system.

Dk indicates dielectric constant or permittivity.

“DIAEA” refers to any of 1,3-diisoalkenylarene, 1,4-diisoalkenylarene and combinations of the 1,3-and 1,4 isomers.

“DVB” refers to divinyl benzene.

“DVA” refers to divinyl arene.

“DIPEB” refers to diisopropenylbenzene. For example, 1,3-DIPEB refers to 1,3-diisopropenylbenzene.

“DIAEA-DVA copolymer” or “DIAEA-DVA polymer” or “DIAEA copolymer” refers to a copolymer of DIAEA and divinylarene (DVA) monomers, and optionally other polymerizable monomer(s) different from DIAEA and DVA.

“CCL” here refers to copper clad laminate, as well as other laminates wherein other metals can be used instead of copper, e.g., aluminum, magnesium, nickel, etc.

“Film” may be used interchangeably with layer, or film layer.

The disclosure relates to a multi-layered laminate containing a plurality of metal foils, a plurality of dielectric (insulating) layers, with at least one of the insulating layers containing a copolymer comprising diisoalkenylarene (DIAEA) and divinylarene (DVA) units as the dielectric polymer, a filler, and optionally a different dielectric polymer, and at least one of the insulating layers containing another dielectric polymer other than the copolymer of DIAEA and DVA, glass fiber, and optional filler. At least one of the insulating layers containing the copolymer of DIAEA and DVA is disposed next to the metal foil. The next sections describe the different materials going into the layers.

(Metal Foil Layer): In embodiments, the metal foil is a copper foil. The copper foil can be electro-deposited or rolled (commonly referred to as raw foil). It may also be surface treated, meaning at least one surface of the foil has undergone treatment to improve various performance characteristics such as corrosion resistance, humidity resistance, chemical and acid resistance, heat resistance, and adhesion to substrates. Surface treatment can be applied to one or both surfaces of the foil.

The surface roughness and mechanical properties of the metal foil can significantly impact its performance. The average surface roughness can be modified through roughening or flattening/smoothing treatments. Average surface roughness is defined as the ten-point average roughness. In embodiments, the foil exhibits a surface roughness within the range of 0.5 to 5 mm. Alternatively, the roughness may be described as less than 5 mm, less than 4 mm, greater than 3 mm, greater than 2 mm, greater than 1 mm, greater than 0.8 mm, or greater than 0.5 mm.

In embodiments, the foil has a maximum surface height (Sz) ranging from 0.15 μm to 6.8 μm. This value may also be specified as less than 6.5 μm, less than 5 μm, less than 3 μm, greater than 0.20 μm, or greater than 0.30 μm.

The thickness of the metal foil layer may vary based on the desired performance or specific application. In embodiments, the metal foil has a thickness ranging from 0.1 μm to 85 μm. Alternatively, the thickness may be specified as less than 85 μm, less than 80 μm, less than 70 μm, less than 60 μm, less than 50 μm, or greater than 12 μm.

In embodiments, the laminate further comprises a second metal foil having surface roughness and thickness characteristics similar to those of the first metal foil.

(Dielectric Polymer—Cross-linkable DIAEA-DVA Copolymer): The dielectric material used herein is a copolymer of (a) a diisoalkenylarene (DIAEA) and (b) a divinylarene (DVA) at a ratio of DIAEA to DVA of 15:1 to 1:15. The copolymer of DIAEA and DVA is as disclosed in U.S. Patent Application Publication 2022/0195109 A1, incorporated herein by reference.

In embodiments, the DIAEA-DVA copolymer has: a Dk (permittivity) of <2.8, or 0.5-2.8, or from 1.0-2.8; a loss tangent (Df) of <0.002, or <0.001, from 0.0003-0.0009, both Dk and Df measured at 1 and 20 GHz, as per NTS (National Technical Systems) and PUS-MRI (Penn State University-Materials Research Institute) test method, measured in accordance with ASTM D2520.

The DIAEA-DVA copolymer can be obtained from DIAEA, DVA, and optionally other polymerizable monomers by cationic polymerization in the presence of a Lewis acid or a Bronsted acid catalyst. In embodiments, the copolymer comprises: polymerized DIAEA in amounts of 30-95, or 35-90, or 40-80, or 20-60, or 30-70 wt. %; polymerized DVA in amounts of 5-70, or 10-65, or 20-60, or 40-80, or 30-70 wt. %; and other polymerized monomers in amounts of 0-15, or 1-12, or 2-10, or 5-15 wt. %, based on total weight of the copolymer.

In embodiments, the DIAEA-DVA copolymer has a mole ratio of DIAEA to DVA of 15:1 to 1:15, or 12:1 to 1:12, or 10:1 to 1:10, or 8:1 to 1:8, or 5:1 to 1:5, or 4:1 to 1:4, or 3:1 to 1:3, or 2:1 to 1:2, or 1:1.

In embodiments, the copolymerized DIAEA monomer comprises at least one of repeat units (A), (B), (C), and (D) whose structures are shown below, where R¹ is Hora C₁-C₈ alkyl group. The DIAEA-DVA copolymer can have any order of the repeat units of copolymerized DIAEA and DVA monomers.

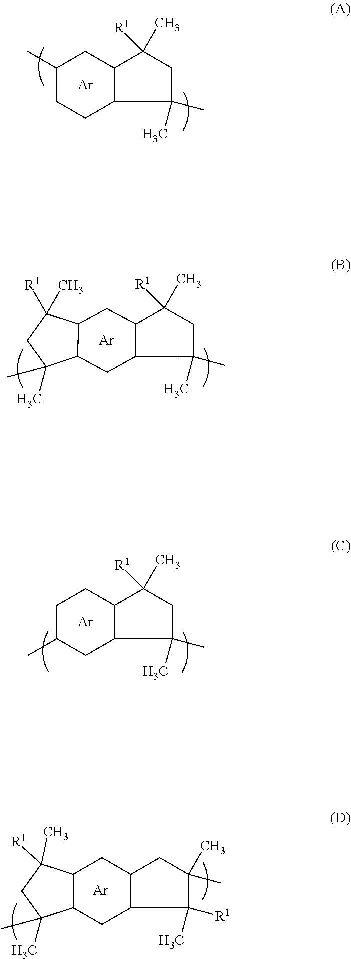

Non-limiting examples of DIAEA monomers to produce the copolymer include compounds having structures (I) 1,3-diisoalkenylarene, (II) 1,4-diisoalkenylarene, or mixtures thereof, wherein R¹ is methyl, ethyl, isopropyl, or n-butyl.

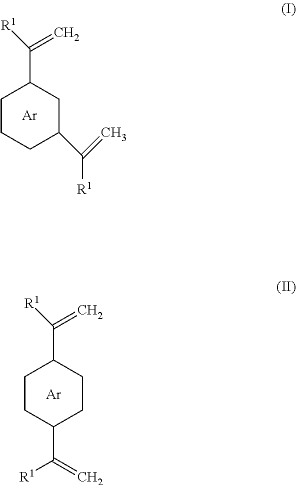

In embodiments, DIAEA is selected from diisopropenylbenzenes (DIPEBs) and their substituted variants for producing the copolymer. Examples of DIPEBs include but are not limited to: 1,3-diisopropenylbenzene; 1,2-diisopropenylbenzene; 1,4-diisopropenylbenzene; 3,4-dicyclohexyl-1,2-diisopropenyl-benzene; 5-(3-methyl-cyclopentyl)-1,3-diisopropenylbenzene; 3-cyclopentyl-methyl-6-n-propyl-1,4-diisopropenylbenzene; 4-(2-cyclo-butyl-1-ethyl)-1,2-diisopropenylbenzene; 3-(2-n-propylcyclopropyl)-1,4-diisopropenylbenzene; 2-methyl-5-n-hexyl-1,3-diisopropenylbenzene; 4-methyl-1,2-diisopropenyl-benzene; 5-ethyl-1,3-diisopropenylbenzene; 3-methyl-1,4-diisopropenylbenzene; and mixtures thereof.

In embodiments, DIAEA is DIPEB comprising o-DIPEB, m-DIPEB, and p-DIPEB. In embodiments, DIPEB contains >75, or >80, or >85, or >90, or >95, or >98, or up to 100 wt. % of m-DIPEB, based on total weight of DIPEB.

In embodiments, DIAEA is DIPEB having a moisture content of <150 ppm, or <120 ppm, or <100 ppm, or <80 ppm, based on total weight of DIPEB.

In embodiments, DIAEA is DIPEB having a 4-tert-buylcatechol (p-TBC) content of <120 ppm, or <100 ppm, or <90 ppm, or <80 ppm, based on total weight of DIPEB.

In embodiments, DIAEA is DIPEB, having a Hazen (APHA) color of <50, or <45, or <40, or <35, or <30, or <20, measured in a 10 wt. % solution of DIPEB in a solvent in accordance with ASTM D1209.

DVA Monomers is copolymerized with a DIAEA monomer. DVA is selected from the group consisting of divinylbenzene (DVB), ethylvinylbenzene (EVB), 1,3-divinylnaphthalene, 1,8-divinylnaphthalene, 1,4-divinylnaphthalene, 1,5-divinylnaphthalene, 2,3-divinylnaphthalene, 2,7-divinylnaphthalene, 2,6-divinylnaphthalene, 4,4′-divinylbiphenyl, 4,3′-divinylbiphenyl, 4,2′-divinylbiphenyl, 3,2′-divinylbiphenyl, 3,3′-divinylbiphenyl, 2,2′-divinylbiphenyl, 2,4-divinylbiphenyl, 1,2-divinyl-3,4-dimethylbenzene, 1,3-divinyl-4,5,8-tributylnaphthalene, 2,2′-divinyl 4-ethyl-4′-propylbiphenyl, and mixtures thereof.

Examples of DVB include o-DVB (1,2-divinylbenzene), p-DVB (1,3-divinylbenzene), m-DVB (1,4-divinylbenzene), trivinylbenzene, or mixtures thereof. In embodiments, DVB comprises two or more compounds selected from o-DVB, m-DVB, p-DVB, vinyl benzene, diethylbenzene, EVB, and mixtures thereof.

In embodiments, DVA is DVB, which comprises m-DVB, p-DVB, m-EVB, p-EVB, and mixtures thereof.

In embodiments, DVA is DVB, which contains 50-99, or 55-95, or 50-85, or 50-80, or >50, or >90, or >97 wt. % of m-DVB, based on total weight of DVB.

In embodiments, DVA is DVB having a weight ratio of m-DVB to p-DVB from 5:1-1:5, or 4:1-1:4, or 3:1-1:3, or 2:1-1:2.

In embodiments, DVA is DVB, which contains 35-45 wt. % m-DVB, 35-45 wt. % p-DVB, 5-15 wt. % m-EVB, and 5-20 wt. % p-EVB, based on total weight of DVB.

In embodiments, DVA has sum of m-DVB, p-DVB, m-EVB, and p-EVB of >80, or >85, or >90, or >92, or >95 wt. %, based on total weight of DVA.

In embodiments, DVA is DVB having a combination of m-DVB and p-DVB in amounts of 50-99, or 55-85, or 50-80, or 55-80, >50, or >85, or up to 99 wt. %, based on total weight of DVB.

In embodiments, DVA is DVB having a combination of m-EVB and p-EVB in amounts of <35, or <30, or <20, or <10, or <5, or 1-25, or <1, or <0.5, or <0.1 wt. %, based on total weight of DVB.

In embodiments, DVA is DVB having a purity of >90%, or >80%, or >70%, or >60%, or >50%, based on total weight of DVB. The “purity” of DVB is defined as the presence of single isomer of greater than certain percentage in the mixture of all isomers, e.g., o-DVB, m-DVB, or p-DVB.

In embodiments, DVA is DVB having a 4-tert-buylcatechol (p-TBC) content of <1200 ppm, or <1100 ppm, or <1000 ppm, or <800 ppm, based on total weight of DVB.

In embodiments, DVA is DVB having a naphthalene content of <1000, or <800, or <700, or <500 ppm, based on total weight of DVB.

In embodiments, the DIAEA-DVA copolymer further comprises other polymerizable monomers selected from the group consisting of styrene, 2-vinylbiphenyl, 3-vinylbiphenyl, 4-vinylbiphenyl, 1-vinylnaphthalene, 2-vinylnaphthalene, α-alkylated styrene, alkoxylated styrene, and mixtures thereof.

Non-limiting examples of α-alkylated styrene include α-methylstyrene, α-ethylstyrene, α-propylstyrene, α-n-butylstyrene, α-isobutylstyrene, α-t-butylstyrene, α-n-pentylstyrene, α-2-methylbutylstyrene, α-3-methylbutyl-2-styrene, α-t-pentylstyrene, α-n-hexylstyrene, α-2-methylpentylstyrene, α-3-methylpentylstyrene, α-1-methylpentylstyrene, α-2,2-dimethylbutylstyrene, α-2,3-dimethylbutylstyrene, α-2,4-dimethylbutylstyrene, α-3,3-dimethylbutylstyrene, α-3,4-dimethylbutylstyrene, α-4,4-dimethylbutylstyrene, α-2-ethylbutylstyrene, α-1-ethylbutylstyrene, α-cyclohexylstyrene, and mixtures thereof. In embodiments, other alkylated styrene compounds include m-methylstyrene, p-methylstyrene, m-propylstyrene, p-propylstyrene, m-n-butylstyrene, p-n-butylstyrene, m-t-butylstyrene, p-t-butylstyrene, m-n-hexylstyrene, p-n-hexylstyrene, m-cyclohexylstyrene, p-cyclohexylstyrene, and mixtures thereof. Examples of the alkoxylated styrene include o-ethoxystyrene, m-ethoxystyrene, p-ethoxystyrene, o-propoxystyrene, m-propoxystyrene, p-propoxystyrene, o-n-butoxystyrene, m-n-butoxystyrene, p-n-butoxystyrene, o-isobutoxystyrene, m-isobutoxystyrene, p-isobutoxystyrene, o-t-butoxystyrene, m-t-butoxystyrene, p-t-butoxystyrene, o-n-pentoxystyrene, m-n-pentoxystyrene, p-n-pentoxystyrene, α-methyl-o-butoxystyrene, α-methyl-mbutoxystyrene, α-methyl-p-butoxystyrene, o-t-pentoxystyrene, m-t-pentoxystyrene, p-t-pentoxystyrene, o-n-hexoxystyrene, m-n-hexoxystyrene, p-n-hexoxystyrene, α-methyl-o-pentoxystyrene, α-methyl-m-pentoxystyrene, α-methyl-p-pentoxystyrene, o-cyclohexoxystyrene, m-cyclohexoxystyrene, p-cyclohexoxystyrene, o-phenoxystyrene, m-phenoxystyrene, p-phenoxystyrene, and mixtures thereof.

In embodiments, other polymerizable monomers include mono, di, or multi-functional compounds selected from butadiene, isoprene, piperylene, divinyltoluene, divinylpyridine, divinylxylene, vinyltriisopropenoxysilane, methoxytrivinylsilane, tetravinylsilane, diethoxydivinylsilane, o-ethylvinylbenzene, m-ethylvinylbenzene, p-ethylvinylbenzene, 2-vinyl-2′-ethylbiphenyl, 2-vinyl-3′-ethylbiphenyl, 2-vinyl-4′-ethylbiphenyl, 3-vinyl-2′-ethylbiphenyl, 3-vinyl-3′-ethylbiphenyl, 3-vinyl-4′-ethylbiphenyl, 4-vinyl-2′-ethylbiphenyl, 4-vinyl-3′-ethylbiphenyl, 4-vinyl-4′-ethylbiphenyl, 1-vinyl-2-ethylnaphthalene, 1-vinyl-3-ethylnaphthalene, 1-vinyl-4-ethylnaphthalene, 1-vinyl-5-ethylnaphthalene, 1-vinyl-6-ethylnaphthalene, 1-vinyl-7-ethylnaphthalene, 1-vinyl-8-ethylnaphthalene, 2-vinyl-1-ethylnaphthalene, 2-vinyl-3-ethylnaphthalene, 2-vinyl-4-ethylnaphthalene, 2-vinyl-5-ethylnaphthalene, 2-vinyl-6-ethylnaphthalene, 2-vinyl-7-ethylnaphthalene, 2-vinyl-8-ethylnaphthalene, 2-vinyl-2′-propylbiphenyl, 2-vinyl-3′-propylbiphenyl, 2-vinyl-4′-propylbiphenyl, 3-vinyl-2′-propylbiphenyl, 3-vinyl-3′-propylbiphenyl, 3-vinyl-4′-propylbiphenyl, 4-vinyl-2′-propylbiphenyl, 4-vinyl-3′-propylbiphenyl, 4-vinyl-4′-propylbiphenyl, 1-vinyl-2-propylnaphthalene, 1-vinyl-3-propylnaphthalene, 1-vinyl-4-propylnaphthalene, 1-vinyl-5-propylnaphthalene, 1-vinyl-6-propylnaphthalene, 1-vinyl-7-propylnaphthalene, 1-vinyl-8-propylnaphthalene, 2-vinyl-1-propylnaphthalene, 2-vinyl-3-propylnaphthalene, 2-vinyl-4-propylnaphthalene, 2-vinyl-5-propylnaphthalene, 2-vinyl-6-propylnaphthalene, 2-vinyl-7-propylnaphthalene, 2-vinyl-8-propylnaphthalene, 1,2,4-trivinylbenzene, 1,3,5-trivinylbenzene, 1,2,4-triisopropenylbenzene, 1,3,5-triisopropenylbenzene, 1,3,5-trivinylnaphthalene, 3,5,4′-trivinylbiphenyl, indene, alkylated indene, such as methylindene, ethylindene, propylindene, butylindene, t-butylindene, sec-butylindene, n-pentylindene, 2-methyl-butylindene, 3-methyl-butylindene, n-hexylindene, 2-methyl-pentylindene, 3-methyl-pentylindene, 4-methyl-pentylindene, alkycoxyindene such as methoxy indene, ethoxy indene, propoxy indene, butoxy indene, t-butoxy indene, sec-butoxy indene, n-pentoxyindene, 2-methyl-butoxyindene, 3-methyl-butoxyindene, n-hexyloxyindene, 2-methyl-pentoxyindene, 3-methyl-pentoxyindene, 4-methyl-pentoxyindene, acenaphthylenes such as alkylacenaphthylenes, halogenated acenaphthylenes, phenylacenaphthylenes, and mixtures thereof. Examples of the alkyl acenaphthylenes include 1-methyl acenaphthylene, 3-methyl acenaphthylene, 4-methyl acenaphthylene, 5-methyl acenaphthylene, 1-ethyl acenaphthylene, 3-ethyl acenaphthylene, 4-ethyl acenaphthylene, 5-ethyl acenaphthylene, and mixtures thereof. Examples of the halogenated acenaphthylenes include 1-chloroacenaphthylene, 3-chloroacenaphthylene, 4-chloroacenaphthylene, 5-chloroacenaphthylene, 1-bromoacenaphthylene, 3-bromoacenaphthylene, 4-bromoacenaphthylene, and 5-bromoacenaphthylene, and mixtures thereof. Examples of the phenylacenaphthylenes include 1-phenylacenaphthylene, 3-phenylacenaphthylene, 4-phenylacenaphthylene, 5-phenylacenaphthylene, and mixtures thereof.

In embodiments, the DIAEA-DVA copolymer further comprises repeat units derived from monomers including: (i) a cyclodiene or a dimer thereof; (ii) an adduct of a cyclodiene and an acyclic diene; (iii) an allyl compound having two or more allyl groups; and any combination or sub-combination thereof. Examples of cyclic polymerizable monomers include 1,3-cyclohexadiene, 1,4-cyclohexadiene, 1,3-cyclopentadiene, alkyl cyclopentadiene, trivinylcyclohexane, 2,4,6,8-tetravinyl-2,4,6,8-tetramethylcyclotetrasiloxane, 2,4,6,8,10-pentamethyl-2,4,6,8,10-pentavinylcyclopentasiloxane, or mixtures thereof.

In embodiments, the DIAEA-DVA copolymer comprises a low molecular weight species in amounts of 0.25-25, or 0.50-20, or 1-15, or 0.25-10, or 0.5-20 wt. %, based on total weight of the copolymer. Low molecular weight species defined as having a molecular weight of <0.5 kg/mol.

(DIAEA-DVA Copolymer Structures): In embodiments, the DIAEA-DVA copolymer is any of a random, or block copolymer. Alternatively, the copolymer can contain a homopolymer of DIAEA monomer end capped with DVA comonomer to obtain a DVA end capped polyDIAEA.

The DIAEA-DVA copolymer can have at least one terminal group selected from (E), (F), (G), and (H), having structures shown below.

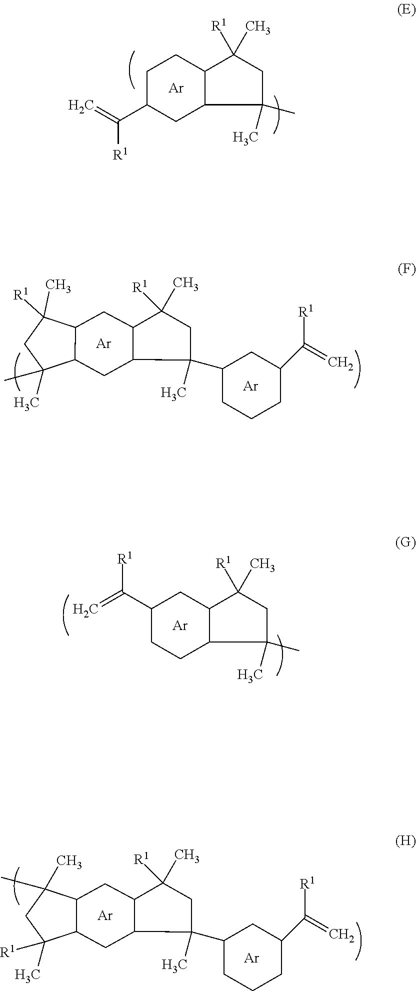

The copolymer can be functionalized with functional groups, such as isocyanate, anhydride, carboxylic acid, carboxylic ester, hydroxyl, vinyl, urethane, amino, phosphino, silane, acrylate, methacrylate, or epoxy groups using methods known in the art.

In embodiments, the DIAEA-DVA copolymer is a DIPEB-DVB copolymer.

(Properties of DIAEA-DVA Copolymers): In embodiments, the DIAEA-DVA copolymer is a resinous material having a good combination of molecular weight ranges and relatively broad molecular weight distributions (polydispersity index), which in part makes it more soluble in non-polar solvents, thereby enhancing their processibility.

In embodiments, the DIAEA-DVA copolymer has a solubility in a hydrocarbon solvent at 25° C. for a period of less than 4 hours of at least 10, or >20, or >30, or >50, or >70, or <99, or 10-75, or 20-65, or 10-60 wt. %, based on total weight of the solvent. Examples of solvents include hexane, heptane, octane, isooctane, cyclohexane, varnish maker and painter's naphtha (VM&P naphtha), petroleum ether, toluene, xylene, and mixtures thereof.

In embodiments, the DIAEA-DVA copolymer as a solid when dissolved in a hydrocarbon solvent forms a substantially gel-free solution, wherein <2, or <5, or <10, or <15 wt. % of the solid remains insoluble in the solvent.

In embodiments, the DIAEA-DVA copolymer solution, in a hydrocarbon solvent, has a Gel Content of 0.05-5, or 0.1-4.5, or 1-4, or <5, or <2, or <1 wt. %, based on total weight of the copolymer.

In embodiments, the DIAEA-DVA copolymer has a decomposition onset temperature of 200-450° C., or 220-420° C., or 240-400° C., or <600° C., or <500° C. or >300° C.

In embodiments, the DIAEA-DVA copolymer has a glass transition temperature (T_{g}) of 50-300° C., or 60-250° C., or 70-220° C., or 80-200° C., or 100-250° C., or 120-220° C. or >150° C., or <250° C., or <200° C., measured using differential scanning calorimetry (DSC) according to ASTM D3418 or dynamic mechanical analyzer (DMA).

In embodiments, the DIAEA-DVA copolymer has a moisture absorption coefficient of <0.1, or <0.08, or <0.05, measured at 25° C. according to ASTM D570.

In embodiments, the DIAEA-DVA copolymer has a density of >0.9, or >1.0, or 1.0-2.0, or 1.0-1.50 g/cc.

(Other Dielectric Polymers): In embodiments, the dielectric layer comprising the DIAEA-DVA copolymer further includes a second dielectric polymer (the “other” dielectric polymer), which may be the same as or different from the “other” dielectric polymer used in the insulating dielectric layer which does not contain the DIAEA-DVA copolymer.

In embodiments, the other dielectric polymer has: a Dk (permittivity) of <5, or 2-5, or from 2.1-4; a loss tangent (Df) of <0.05, or <0.0002, from 0.0003-0.05, both Dk and Df measured at 10 GHz, as per NTS (National Technical Systems) and PUS-MRI (Penn State University-Materials Research Institute) test method, measured in accordance with ASTM D2520.

Examples of the other dielectric polymer include epoxy resin, polyimide resin, bismaleimide-triazine (BT) resin, cyanate ester resin, benzoxazine resin, phenolic resin, maleimide resin, styrenic block copolymer (SBCs), hydrogenated styrenic block copolymer (HSBC), polytetrafluoroethylene (PTFE), polyphenylene ether (PPE), polyetherimide (PEI), polyphenylene sulfide (PPS), polyether sulfone (PES), polysulfone (PSU), polyether ketone (PEEK), polycarbonates (PC), polyolefins including polyethylene and polypropylene, polyethylene terephthalate (PET), polybutylene terephthalate (PBT), polyesterimides, polyurethanes, and fluorine resins including polyvinylidene fluoride (PVDF), and mixtures thereof.

In embodiments, the other dielectric polymer is an epoxy resin comprising any of glycidyl groups, alicyclic epoxy groups, oxirane groups, ethoxyline groups, and the like. Examples of the epoxy resins include novolac-type epoxy resin, cresol-novolac epoxy resin, triphenolalkane-type epoxy resin, aralkyl-type epoxy resin, aralkyl-type epoxy resin having a biphenyl skeleton, biphenyl-type epoxy resin, dicyclopentadiene-type epoxy resin, heterocyclic-type epoxy resin, epoxy resin containing a naphthalene ring, a bisphenol-A type epoxy compound, a bisphenol-F type epoxy compound, stilbene-type epoxy resin, trimethylol-propane type epoxy resin, terpene-modified epoxy resin, linear aliphatic epoxy resin obtained by oxidizing olefin bonds with peracetic acid or a similar peracid, alicyclic epoxy resin, sulfur-containing epoxy resin, N,N, N′,N′-tetraglycidyl-m-xylenediamine, N,N,N′,N′-tetraglycidylmethylenedianiline, anthracene based epoxy resin, pyrene based epoxy resin, naphthalene based epoxy resin, and mixtures thereof. In embodiments, naphthalene-based epoxy resins include di-naphthalene based epoxy resin, tetra-naphthalene based epoxy resin, oxazolidone-containing di-naphthalene based epoxy resin, and the like.

In embodiments, the other dielectric polymer is a cyanate ester resin comprising at least a unit of —O—CN. Cyanate esters can contain units of Ar—O—CN, wherein Ar is substituted or unsubstituted benzene, biphenyl, naphthalene, phenol novolac, bisphenol A, bisphenol A novolac, bisphenol F, bisphenol F novolac, or phenolphthalein. The Ar can be bonded with substituted or unsubstituted dicyclopentadienyl. The cyanate ester resin can be obtained from compounds selected from but not limited to polyfunctional aliphatic isocyanate compounds, polyfunctional alicyclic isocyanate compounds, polyfunctional aromatic isocyanate compounds such as trimethylene diisocyanate, tetramethylene diisocyanate, methylene diisocyanate, pentamethylene diisocyanate, 1,2-propylene diisocyanate, 1,3-butylene diisocyanate, dodecamethylene diisocyanate, 2,4,4-trimethyl hexamethylene diisocyanate and the like, 1,3-cyclopentene diisocyanate, 1,3-cyclohexane diisocyanate, 1,4-cyclohexane diisocyanate, isophorone diisocyanate, hydrogenated diphenylmethane diisocyanates, hydrogenated xylylene diisocyanate, hydrogenated tolylene diisocyanate, hydrogenated tetramethylxylylene diisocyanate, phenylene diisocyanate, 2,4-tolylene diisocyanate, 2,6-tolylene diisocyanate, 2,2′-diphenylmethane diisocyanate, 4,4′-diphenylmethane diisocyanate, 4,4′-toluidine diisocyanate, 4,4′-diphenyl ether diisocyanate, 4,4′-diphenyldiisocyanate, 1,5-naphthalene diisocyanate, benzene methylene diisocyanate, 2,4′-diphenyl methane diisocyanate, 4,4′-diphenyl methane diisocyanate, carbodiimide modified product of 4,4′-diphenyl methane diisocyanate, polymethylene polyphenyl polyisocyanate, tolidine diisocyanate, xylene diisocyanate, tetramethyl xylene diisocyanate, hydrogenated diphenyl methane diisocyanate, hydrogenated xylene diisocyanate, norbonane diisocyanate, biuret modified hexamethylene diisocyanate, dimeric acid diisocyanate, and the like.

In embodiments, the other dielectric polymer is a benzoxazine resin, e.g., bisphenol A benzoxazine, bisphenol F benzoxazine, phenolphthalein benzoxazine, and the like and mixtures thereof.

In embodiments, the other dielectric polymer is a polyphenylene ether, e.g., polyphenylene oxide (PPO), polyphenylene ether oligomers or polymers. The polyphenylene ether can be functionalized with hydroxyl, vinyl, isocyanate, anhydride, carboxylic acid, carboxylic ester, urethane, amino, phosphino, epoxy, silane, acrylate, methacrylate, and mixtures thereof. In embodiments, the polyphenylene ether has 1.2 to 2.8 phenolic hydroxy groups per molecule and polydispersity index of 1.2-3, intrinsic viscosity of 0.03-0.2 deciliter per gram.

In embodiments, the other dielectric polymer is a polyurethane obtained by reacting isocyanates and polyols, in the presence of a thermal or photo initiator. Examples of isocyanates can include isocyanates described above under cyanate ester resin. Examples of the polyol include an alkylene oxide adduct of bisphenol A, an alkylene oxide adduct of aromatic diol, polyester polyol, acryl polyol, polyether polyol, polycarbonate polyol, polyalkylene polyol, and the like. Other types of hydroxyl group containing compounds which can be used as polyols in the preparation of the polyurethane include 2-hydroxy ethyl (meth)acrylate, 3-hydroxy propyl (meth)acrylate, 4-hydroxy-n-butyl (meth)acrylate, 2-hydroxy propyl (meth)acrylate, 2-hydroxy-n-butyl (meth)acrylate, 3-hydroxy-n-butyl (meth)acrylate, and mixtures thereof. A molar ratio of an isocyanate group (NCO) of the isocyanate compound to a hydroxyl group (OH) of the polyol is from 0.7 to 1.5, or 0.8 to 1.3, or 0.8 to 1.0.

In embodiments, the other dielectric polymer comprises a styrenic block copolymer (SBC). The SBC may be unhydrogenated, hydrogenated, partially hydrogenated, selectively hydrogenated, or a mixture thereof. In embodiments, the SBC may be either a linear or branched (e.g., multi-arm) block copolymer, comprising at least one polymer block A derived from a vinyl aromatic monomer and at least one polymer block B derived from a conjugated diene monomer. The vinyl aromatic monomer can be introduced into or copolymerized with the conjugated diene blocks in any sequence and distribution. In embodiments, the styrenic block copolymer is a hydrogenated SBC having a general configuration selected from S-EB-S, S-E/P, S-E/B, S-EP-S, and mixtures thereof. In these configurations, each “S” block is derived from a vinyl aromatic monomer, “EB” denotes an ethylene-butylene block, and “EP” denotes an ethylene-propylene block.

(Filler): In embodiments, filler is added to the dielectric layer containing the copolymer of DIAEA-DVA in amounts of 30-60 wt. %, or >30 wt. %, or >40 wt. %, or >50 wt. %, or <60 wt. %, based on total weight of the layer. In embodiments, filler is also added to the dielectric layer containing the other dielectric polymer (other than copolymer of DIAEA-DVA) in amounts of 0-30 wt. %, or >30 wt. %, or >25 wt. %, >20 wt. %, >15 wt. %, or >10 wt. %, >5 wt. %, or >2 wt. % based on total weight of the layer.

Examples of filler include silica, alumina, barium sulfate, talc, clay, mica powder, aluminum hydroxide, magnesium hydroxide, calcium carbonate, magnesium carbonate, magnesium oxide, boron nitride, aluminum borate, barium titanate, strontium titanate, calcium titanate, magnesium titanate, bismuth titan ate, titanium oxide, barium zirconate and calcium zirconate, and mixtures thereof.

In embodiments, filler is a silica selected from the group consisting of: aerogel silica, silica xerogels, fumed silica, precipitated silica, amorphous silica, crystalline silica, hollow silica, and mixtures thereof. The silica can be derived from silicates, such as an alkali metal silicate, or ammonium silicate. In embodiments, silica has a spherical shape with an aspect ratio of ≤2, or ≤1.5, or ≤1. In embodiments, silica has a surface area of ≥1, or ≥2, or ≥5, or 1-60, or 5-30, or 10-50, or 1-15 m²/g.

In embodiments, filler is an elongated particle having an aspect ratio of ≥2.0, or >1.5, or ≥ 1.0. In embodiments, filler has an average particle size of ≥10 nm, or ≥20 nm, or ≥50 nm, or ≥100 nm, or ≥150 nm, or 10 nm-1 microns, 20 nm-500 nm, 20 nm-200 nm, or 10 nm-100 nm, 50 nm-300 nm, or <5 μm, or <2 μm, or <1 μm, or <0.8 um, or <0.6 μm.

In embodiments, filler is surface treated with at least one surface treating agent to enhance dispersibility of filler in the copolymer layer, in an amount of 0.1-10, or 0.5-5, or 0.1-3, or 0.2-2.5 wt. % of surface treating agent based on total weight of the filler. Examples of surface treating agents include silane coupling agents, titanium coupling agents, aluminum coupling agents, organosilazane compounds, etc. Other examples include methacrylic silane, acrylic silane, amino silane, imidazole silane, vinyl silane, epoxy silane, fluorine-containing silane, mercapto silane, alkoxy silanes, and mixtures thereof. Examples of silane include 3-glycidoxypropyltrimethoxysilane, 3-mercaptopropyltrimethoxysilane, 3-aminopropyltriethoxysilane, N-phenyl-3-aminopropyltrimethoxysilane, hexamethyldisilazane, phenyltrimethoxysilane, 3,3,3-trifluoropropyltrimethoxysilane, vinyltrimethoxysilane (VTMOS), vinyltriethoxysilane (VTEOS), vinyltributoxysilane, vinyldimethoxyethoxysilane, vinyldimethoxybutoxysilane, vinyldiethoxybutoxysilane, allyltrimethoxysilane, allyltriethoxysilane, methacryloxypropyltrimethoxysilane, methacryloxypropyltricthoxysilane, dimethoxymethylsilane, diethoxymethylvinylsilane, p-styryltrimethoxysilane, p-styryltriethoxysilane, and mixture thereof.

(Glass Fiber): In embodiments, the insulating layer containing the other dielectric polymer (and free of the DIAEA-DVA copolymer) further contains glass fiber in amounts of at least 75 wt. %, at least 80 wt. %, at least 85 wt. %, or at least 90 wt. %, with the balance being the second dielectric polymer; or a ratio of glass fiber to other dielectric polymer in weight ratios of 70:30 to 95:5, or 75:25, or 80:20, or 82:18, or 85:15, or 90:10. Examples of glass fiber include glass cloth, aramid cloth, polyester cloth, glass non-woven cloth, aramid non-woven cloth, polyester non-woven cloth, pulp paper, and linter paper.

In embodiments, glass fiber is added to the other dielectric polymer forming a varnish mixture. In other embodiments, the other dielectric polymer is impregnated onto a glass fiber cloth. In embodiments, the weight ratio of the glass fiber to the other dielectric polymer is 75:25, or 80:20, or 82:18, or 85:15, or 90:10, or 95:5.

(Optional Additives): In embodiments, anti-scorching agents are added to the dielectric layer containing the copolymer of DIAEA and DVA. Examples of anti-scorching agents include styrene, alpha-methyl styrene monomer (AMSM), alpha-methyl styrene dimer (AMSD), alpha-methyl styrene oligomer (AMSO), hindered phenolic compounds which are substituted by an alkyl group, a phenyl group, or the like at the ortho position to at least one phenolic OH group, non-hindered phenolic compounds, amine compounds, thiourea compounds, benzimidazoles, mixtures and derivatives thereof. The alpha-methyl styrene derivatives can have one or more functional groups located on each ring and can be all same or different. In embodiments, alpha-methyl styrene dimer is selected from the group consisting of 2,4-diphenyl-4-methyl-1-pentene, 2,4-diphenyl-4-methyl-2-pentene, 1,2-dimethyl-3-phenylindane, cis-1,3-dimethyl-1,3-diphenyl cyclobutene, trans-1,3-dimethyl-1,3-diphenyl cyclobutene, and mixtures thereof.

In embodiments, anti-scorching agent is added to the DIAEA-DVA copolymer in solution, in amounts of 0.001-10, or 0.005-10, or 0.010-10, or 0.050-10, or 0.001-5, or 0.005-5, or 0.010-5, or 0.050-5, or up to 5 wt. %, based on total weight of the DIAEA-DVA copolymer.

In embodiments depending on the dielectric polymer(s) used, the dielectric layer further contain at least an additive selected from initiators, activators, stabilizers, neutralizing agents, thickeners, coalescing agents, slip agents, release agents, antioxidants, antiozonants, color change pH indicators, plasticizers, tackifiers, film forming additives, dyes, pigments, UV stabilizers, fillers, flame retardants, viscosity modifiers, wetting agents, deaerators, toughening agents, adhesion promoters, heat stabilizers, lubricants, flow modifiers, drip retardants, antistatic agents, processing aids, stress-relief additives, accelerator, water resistant agents, water-proofing agents, thermal conductivity-imparting agents, electromagnetic wave shielding property-imparting agents, radical scavengers, and mixtures thereof.

Additives can be added to the layer in an amount up to 30, or 0.1-30, or 0.1-20, or 1-10, or 0.5-5, or 0.1-5 wt. %, based on total weight of the dielectric polymer in the particular layer.

(Structure of the Laminate): The laminate is characterized as having multilayered sandwich structure with alternating metal foil layers and insulating layers, with the insulating layers containing materials as described above, and with the insulating dielectric layer containing the DIAEA-DVA copolymer to be adjacent to the metal foil layer.

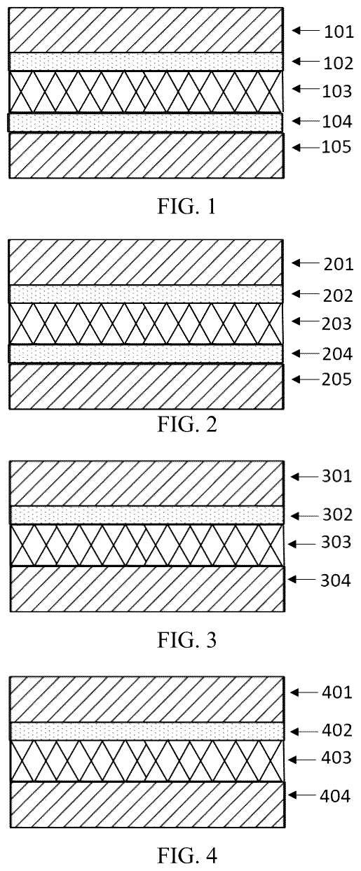

In embodiments, the insulating dielectric layer adjacent to the metal foil layer comprises a DIAEA-DVA copolymer in an amount of 40-70 wt. %, or 45-65 wt. %, or 50-60 wt. %, based on the total weight of the composition in the first layer (see FIG. 1 and description below). In embodiments, in addition to the DIAEA-DVA copolymer and the filler, the other dielectric polymer can be added to this layer at a weight ratio of the other dielectric polymer to the DIAEA-DVA copolymer from about 1:20 to 1:4, or from 1:15 to about 1:5, or 1:10 to 1:6.Also see description of FIG. 2 below.

In embodiments, the thickness of the insulating layer containing DIAEA-DVA copolymer and filler ranges from 3-25 μm, or 5-15 μm, or 7.5-12 μm, or <25 μm, <20 μm, <15 μm, or >3 μm, or >5 μm, >7.5 μm.

In embodiments, the insulating dielectric layer containing the DIAEA-DVA copolymer is characterized as having a Dk of <2.8, or <2.5, or <2.1, or <2.0, or <1.8 and a Df of <0.002, or <0.001, or <0.0008, or <0.0007, or <0.0005.

In embodiments, the insulating layer adjacent to the layer containing the DIAEA-DVA copolymer contains glass fiber(s) and at least one other dielectric polymer in amounts of 15-50%, or 20-40%, 25-35%, or >15%, or >20%, or >25%, or >30%, or <50%, or <45%, or <40%.

In embodiments, the thickness of the insulating layer containing other dielectric polymer (other than DIAEA-DVA copolymer) and glass fiber ranges from 50-200 μm, 60-150 μm, or 70-120 μm, or >50 μm, or >60 μm, or >65 μm, or >75 μm, or >85 μm, or >100 μm, or >115 μm, or <200 μm.

In embodiments, the insulating dielectric layer containing the other dielectric polymer (other than DIAEA-DVA copolymer) is characterized as having a Dk of <5.0, or <4.8, or <4.5, or <4.0, or <3.8, or <3.5, or <3.0, and a Df of 0.0003-0.05, or <0.05, <0.01, or <0.005, or <0.002, or <0.001.

Embodiments of the multi-layered laminate are as illustrated in the figures. In FIG. 1, the multi-layered laminate structure comprising a first metal foil layer (101) and a second metal foil layer (105), the first dielectric insulating layer (102) and the second dielectric insulating layer (104) containing DIAEA-DVA copolymer and filler placed adjacent to the first and second metal foil respectively. Positioned between the two dielectric insulating layers containing DIAEA-DVA copolymer is a layer (103) comprising glass fiber and at least another dielectric polymer (other than a DIAEA-DVA copolymer). This symmetrical laminate architecture enables a scalable, repeatable stacking strategy, wherein thin, low-loss dielectric layers (i.e., containing the DIAEA-DVA copolymer) are alternated with thicker, mechanically reinforced dielectric layers to achieve optimal performance in high-frequency applications.

FIG. 2 depicts another embodiment of the multilayered laminate structure, structurally similar to the configuration of FIG. 1, except that the dielectric layers adjacent to the metal foil layer further comprise another dielectric polymer in addition to the DIAEA-DVA copolymer. The dielectric layers with DIAEA-DVA copolymer are positioned for the low-loss interface to be optimally placed between the metal foil conductors and the glass-reinforced dielectric layer (203).

FIG. 3 illustrates a further embodiment of a multilayered laminate stack comprising two outer metal foils (301 and 304), with the dielectric layer (302) with DIAEA-DVA copolymer being placed adjacent to the metal foil layer (301), and the dielectric layer (303) containing another dielectric polymer (other than DIAEA-DVA copolymer) being placed adjacent to the metal foil layer (304). This construction provides a dual-dielectric configuration with metal layers on both outer surfaces, making it particularly advantageous for controlled impedance and EMI shielding.

FIG. 4 depicts yet another embodiment of the multilayered laminate architecture. This configuration is similar to the structure in FIG. 3 except that in addition to DIAEA-DVA copolymer and filler, the dielectric layer (402) further comprises another dielectric polymer (other than the DIAEA-DVA copolymer). The resulting architecture enables the design of high-density multilayered circuit boards with excellent signal integrity, low dielectric loss, and tight impedance control across stacked signal and ground planes.

(Method to Prepare the Multi-Layered Laminate): The construction of the laminate may be carried out by various methods, which may differ in terms of the order in which layers are assembled, the technique by which dielectric layers are applied, and the source or form of intermediate materials used, including prepregs (which can be commercially available) or dielectric varnishes.

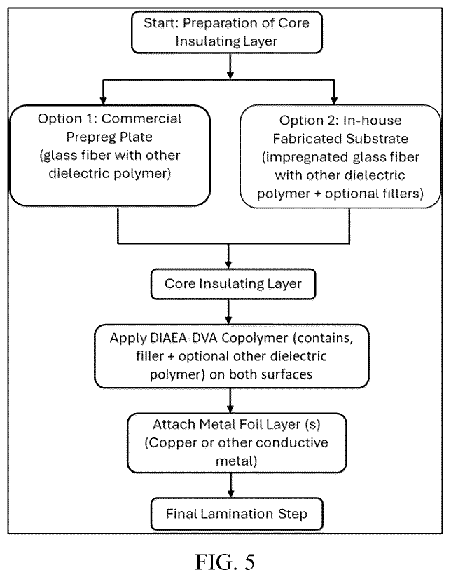

FIG. 5 is a schematic process flow diagram illustrating a method to construct a multi-layered laminate structure, which comprises one or more metal foil layers, at least one thin dielectric layer containing a DIAEA-DVA copolymer, and at least a thicker insulating layer comprising a glass fiber component and another dielectric polymer distinct from the DIAEA-DVA copolymer.

In one embodiment as shown, the process begins with the core insulating layer (layer not containing DIAEA-DVA copolymer) which can be fabricated in-house (option 2), or a commercially available prepreg (option 1). Either option serves as the foundational layer for the subsequent laminate stack-up. Commercially available prepreg is a sheet comprising glass fibers embedded in another dielectric polymer such as epoxy or cyanate ester. This prepreg can be cured or semi-cured. In order to fabricate the core insulating layer, a glass fiber substrate is impregnated with dielectric polymer(s) other than DIAEA-DVA copolymer). The impregnating solution may include optional fillers to enhance performance.

In the next step, a composition (uncured or partially cured) containing DIAEA-DVA copolymer, filler, and optional other dielectric polymer is applied to both surfaces of the core insulating layer. This can be done via methods like brushing, roll coating, or die coating, depending on the process setup. One or two metal foil layers (typically copper or other conductive metals) are then placed onto the copolymer-coated surfaces of the core layer. These layers serve as conductive planes or signal layers in the final laminate. The assembled stack is then subjected to lamination, which involves applying heat and pressure using thermal pressing or vacuum molding. This step promotes interlayer adhesion and simultaneously completes the curing of the DIAEA-DVA copolymer.

In another embodiment, the process begins with a metal foil, onto which the partially cured DIAEA-DVA copolymer composition (comprising filler and optional other dielectric polymer) is die-coated. The coated foil is then brought into contact with a cured insulating layer to form part of the laminate structure. This sequence can be repeated to generate a symmetrical laminate configuration. The complete structure is then subjected to heat and pressure to finalize bonding and curing.

In yet another embodiment, the insulating layer (in-house) can be prepared by impregnating a fiberglass mat with another dielectric polymer solution in varnish form, thereby forming a prepreg. The partially cured DIAEA-DVA copolymer (comprising filler and optional other dielectric polymer) is then applied to one or both surfaces of this prepreg, after which one or more metal foils are placed on the coated surfaces. Lamination under appropriate conditions yields a fully cured and bonded laminate.

In cases where improved adhesion between layers is desired, the metal foil surfaces can be chemically treated prior to assembly. For example, a silane coupling agent may be used to treat the inner surfaces of the metal foils. The method proceeds by first preparing a cured prepreg insulating layer, followed by application of the DIAEA-DVA copolymer formulation onto both surfaces of the prepreg. The chemically treated metal foils are then positioned on either side of the coated prepreg. Vacuum lamination-molding is carried out at an elevated temperature, such as between 180° C. and 250° C., to ensure curing of the copolymer and formation of strong adhesive bonds throughout the laminate.

In another embodiment, a commercially available prepreg sheet containing fiberglass and a cured or semi-cured dielectric resin is employed directly as the core insulating layer. This alternative enables faster laminate assembly, as the DIAEA-DVA copolymer layers can be applied directly to the commercial prepreg surfaces, followed by lamination with one or more metal foil layers.

To further enhance bonding, optional intermediate adhesive layers or dielectric varnishes can be included in the laminate stack. These varnishes are incorporate one or more additives, such as tackifiers, dielectric resins, fillers, pigments, and curing agents. Such varnishes may be applied to any of the relevant surfaces, including the prepreg, the metal foil, or the DIAEA-DVA copolymer layers, prior to final lamination.

This architecture allows for precise control of electrical loss, impedance, and mechanical rigidity, making it suitable for high-frequency circuit substrates, antenna components, multilayer signal routing platforms, and other applications requiring low-loss and structurally robust dielectric materials.

In embodiments, the resultant laminate structure comprises one or more thin dielectric layers containing the DIAEA-DVA copolymer. These layers have a thickness in the range of approximately 3 to 20 micrometers and exhibit dielectric constants (Dk) less than 2.8 and dissipation factors (Df) less than 0.002, measured at 10 GHz. Thicker insulating dielectric layers comprising glass fiber and another dielectric polymer which exhibits dielectric constants below 5.0 and dissipation factors below 0.05. Lamination is carried out using thermal pressing or vacuum lamination at pressures ranging from approximately 0.5 to 2 MPa.

(Properties of Laminate): The laminate comprising DIAEA-DVA copolymer layer with a thickness of 5-200 μm exhibits excellent dielectric properties and effectively prevents the peeling of wiring.

Adhesion Strength with Copper Foil: In embodiments, the laminate has a 90° peel strength to copper foil of >0.1, or >0.2, or 0.1-1.0, or 0.2-0.9, or 0.3-0.7 N/m, performed according to IPC 650 2.4.19.

In embodiments, the laminate has a decomposition temperature (Td) of <500° C., or <450° C., or >100° C., or >150° C., or >175° C. or >200° C., as measured using thermogravimetric analysis (TGA) at 5 wt. % loss.

In embodiments the laminate has a glass transition temperature (Tg) of from 150° C. to 300° C., or <300° C., or <280° C., or >150° C. measured using DSC according to ASTM D3418 or DMA (dynamic mechanical analyzer).

In embodiments, the laminate after curing has a coefficient of thermal expansion (CTE) of <30, or <28, or <25, or <22 ppm/° C., as measured using TMA over a range of −50 to 300° C.

In embodiments, the laminate has a Dk (permittivity) of <4.5, or <4, or <3.5, or <2.80, or <2.70, or <2.60, or <2.50, or <2.40, measured at 10 GHz, according to ASTM D2520.

In embodiments, the laminate has a Df (loss tangent) of <0.01, or <0.005, or <0.0018, or <0.0015, or <0.0005, or <0.0006, or 0.002-0.0001, or 0.0015-0.0001, measured at 10 GHz, according to ASTM D2520.

Heat Resistance-The heat resistance (T288) of the metal-clad laminate is evaluated in accordance with IPC TM650. Specifically, with use of a thermal mechanical analyzer (TMA), the metal-clad laminate was heated to 288° C., and the period of time until delamination occurred is measured.

(Applications): The DIAEA-DVA copolymers can be used in coating applications for automotive, e.g., refinishes, primers, basecoats, undercoats, overcoats, clear coats, etc. Power cables can be obtained from the thermosetting polymers e.g. DIAEA-DVA copolymers, particularly cables in high voltage applications, and useful in both alternating current (AC) and direct current (DC) applications.

In embodiments, the DIAEA-DVA copolymer (comprising filler and optional other dielectric polymer) can be used in the preparation of prepregs, laminated boards, or printed circuit boards (PCBs).

In embodiments, the DIAEA-DVA copolymer (comprising filler and optional other dielectric polymer) is used in the manufacturing of copper clad laminates (CCL). Such laminates can be used to fabricate components such as flexible or rigid laminated circuit boards that can be incorporated into end-use devices, e.g., televisions, computers, laptop computers, tablet computers, printers, cell phones, video games, DVD players, stereos, electronic encapsulants, and other consumer electronics.

The laminate can be used in a high frequency band application, e.g., with signal frequencies of >10 GHz. Such applications include automobile antennae, cellular phone base station antennae, high performance servers, anti-collision radars, base station servers, routers, etc.

(Analytical Methods): In embodiments, the laminate includes a first insulating layer comprising DIAEA-DVA copolymer, optionally blended with another dielectric polymer and further comprising a defined amount of filler. This first insulating layer is positioned adjacent to a second insulating layer comprising a conventional dielectric polymer material such as a glass-filled epoxy. Each layer is defined not only by its composition but also by electrical properties—specifically, a dielectric constant (Dk) and dissipation factor (Df) at 10 GHz—as well as a specified relative thickness.

To detect the presence of the claimed layered structure, a cross-sectional analysis of the laminate may be performed using cryogenic microtomy, focused ion beam (FIB) milling, or mechanical sectioning. The resulting cross-section may be examined using optical microscopy or scanning electron microscopy (SEM) to determine the number, order, and relative thickness of the layers. The first insulating layer can further be characterized for filler loading and morphology using energy-dispersive X-ray spectroscopy (EDS/EDX) or thermogravimetric analysis (TGA), enabling confirmation that the filler is present in the defined range (e.g., 30-60 wt. %) and has the preferred particle size (e.g., 3-5 μm).

To confirm the dielectric properties of each individual layer, samples of the separated layers may be tested in accordance with ASTM D2520 or equivalent high-frequency methods to measure Dk and Df at 10 GHz. If layer separation is not feasible, spatially resolved dielectric characterization may be performed using scanning microwave microscopy (SMM), which enables localized measurement of Dk and Df across the laminate cross-section with micron-scale precision. These methods can confirm that the copolymer layer has a dielectric constant of less than 2.8 and a dissipation factor of less than 0.002, while the adjacent dielectric polymer layer exhibits a higher Dk and Df within the limits specified in the claims (e.g., Dk<5.0, Df <0.05).

In certain cases, modeling techniques may also be employed to estimate the dielectric contribution of the individual layers from bulk measurements, using known dielectric values and thickness data to reconstruct the laminate's performance and infer the presence of a high-performance copolymer layer. Spectroscopic techniques such as Fourier-transform infrared (FTIR) mapping, Raman spectroscopy, or solid-state nuclear magnetic resonance (NMR) may further be used to identify the chemical structure of the copolymer layer and distinguish it from conventional dielectric polymers.

The molecular composition of a DIAEA-DVA copolymer can be detected in the laminate using Nuclear Magnetic Resonance (NMR) Spectroscopy, including both proton (¹H) and carbon (¹³C) NMR. Characteristic chemical shifts corresponding to the alkenyl and aromatic moieties of both diisoalkenylarene and divinylarene units are identifiable in the NMR spectra. Integration of the relevant peaks enables quantitative determination of the mole ratio of the two monomeric units, thereby confirming compliance with the claimed molar ratio range (from 15:1 to 1:15). Copolymer samples may be dissolved or swelled in appropriate deuterated solvents to enable such analysis using a high-field NMR spectrometer.

(Examples): The following examples are intended to be non-limiting.

The following materials and test methods are used.

Metal foil-Cu foil having a thickness of 25-50 μm, and surface roughness of 0.5 to 5 mm.

First insulating layer-DIAEA-DVA copolymer (15:1 to 1:15), filler and an optional first dielectric polymer (a linear triblock copolymer based on styrene and ethylene/butylene).

Second insulating layer-Glass fiber impregnated with epoxy resin (FR4). Woven fiberglass cloth with an epoxy resin binder that is flame resistant.

Other dielectric polymer—(S-E/B-S) is a linear triblock copolymer based on styrene and ethylene/butylene, having a molecular weight of 55 kg/mol, a butylene unit content of 39%, and a vinyl aromatic unit content of 31 wt. %.

Other dielectric polymer-brominated Epoxy-tetrabromobisphenol A epoxy resin, having mol. wt (Mn) of 1000-5000 g/mol, epoxy equivalent weight (EEW) of 350-500 g/eq, Tg of 130-150° C., and density of ˜1.2-1.3 g/cm³.

Comparative sample 5-commercial halogen free epoxy resin material sandwiched between 2 metal foils (Cu), fiber glass laminate (0.2 mm) as insulating layer.

Comparative sample 6-commercial PPE material sandwiched between 2 metal foils (Cu), fiber glass laminate (0.2 mm) as an insulating layer.

Glass transition temperature (Tg) is measured by Dynamic Mechanical Analysis (DMA) according to ASTM 4065. Temperature sweep experiments were conducted from −80 to 200° C. with a heating ramp of 2° C./min and at 10 rad/s in the shear mode unless specified otherwise, where storage moduli (G′), loss moduli (G″), and loss factors (tan δ) were obtained as a function of temperature.

(Example 1—Preparation of First Insulating Layer): A first insulating layer is prepared using a copolymer of DIAEA-DVA, a filler, and optionally another dielectric polymer. The film is formed by solution casting the DIAEA-DVA copolymer composition onto a polyethylene terephthalate (PET) support. After casting, the film is dried at room temperature by transferring it onto a PET release liner. Subsequently, it is thermally cured by heating at a temperature ranging from 120° C. to 180° C. The resulting film exhibits the following properties, Gel Content: >90%, Dk: <2.8, and Df: <0.002.

(Example 2—Preparation of Second Insulating Layer): The second insulating layer is an insulating layer produced by impregnating glass fiber (0.3 mm thickness) with an epoxy resin (dielectric polymer) at a weight ratio of 80:20 to 90:10 (epoxy: glass fiber). The impregnation is performed by immersing the glass fiber in an organic solvent selected from methyl ethyl ketone (MEK), cyclohexane, toluene, tetrahydrofuran (THF), or mixtures thereof. After impregnation, the material is dried and subjected to thermal treatment at 80° C. to 180° C. for a duration of 1 to 10 minutes. The final second insulating layer demonstrates: Dk: <5, and Df: <0.05.

(Example 3-6) Fabrication of Laminate Structure-Examples 3 to 6 illustrate various embodiments of laminate structures, as summarized in Table 1. In each case, a 50 μm thick copper foil is laminated onto the first insulating layer. The assembly is subjected to vacuum pressing under the following conditions: Pressing Temperature: 190° C., Holding Time: 90 minutes, and a Pressure: 400 N.

TABLE 1

| | | | First Layer | | | Second | | |
|---|---|---|---|---|---|---|---|---|
| | | | | | Other | Insulating | Second | |
| | | | Copolymer | Filler | Dielectric | Layer | Insulating | |
| Example | Metal Foil | | DIAEA-DVA | (silica) | Polymer | (Glass:Epoxy | Layer | |
| (Ex) | (Cu)Thickness | | (wt. %) | (wt. %) | (wt. %) | %) | Thickness | |
| Ex 3 | 18 | μm | 65 (10:1) | 35 | 0 | 85:15 | 100 | μm |
| Ex 4 | 35 | μm | 60 (1:1) | 35 | 5 | 88:12 | 120 | μm |
| Ex 5 | 12 | μm | 65 (3:1) | 35 | 0 | 80:20 | 90 | μm |
| Ex 6 | 25 | μm | 63 (1:5) | 35 | 2 | 90:10 | 150 | μm |

Table 2 summarizes the properties of Samples 1-4 prepared according to Examples 3-6. For comparison, the table also includes the properties of Comparative Samples 5 and 6, which represent conventional products. All samples, including the comparative ones, were prepared following the process outlined in Example 3.

TABLE 2

| | Z-CTE % (ppm/° C.) | | Td (° C.) | | | |
|---|---|---|---|---|---|---|
| | α 1 | α 2 | TGA 5 | T288 min | | |
| | (before | (after | wt. % | (thermal | Dk at | Df at |
| Properties | Tg) | Tg) | loss | decomposition) | 10 GHz | 10 GHz |
| Sample 1 (Ex-3) | 37.85 | 130.17 | 417.07 | >60 | 2.6 | 0.000542 |
| Sample 2 (Ex-4) | 15.55 | 65.85 | 450 | >60 | 3.2 | 0.000478 |
| Sample 3 (Ex-5) | 29.88 | 78.58 | 450 | >60 | 2.45 | 0.00067 |
| Sample 4 (Ex-6) | 37.85 | 130.17 | 417.07 | >60 | 2.6 | 0.000542 |
| Sample 5 (Comparative) | 14.75 | 49.38 | 320 | >60 | 3.6 | 0.00075 |
| Sample 6 Comparative | 16.28 | 65.73 | 370 | >60 | 3.4 | 0.0023 |

The inventive laminate samples (Samples 1-4) demonstrated superior performance across key parameters when compared to conventional samples. Sample 2 exhibited the lowest coefficient of thermal expansion (15.55 ppm/° C.), comparable to commercial materials, while Samples 1 and 4 showed higher but controlled expansion. Thermal stability was markedly improved in Samples 2 and 3, each with a degradation threshold of 450° C., significantly exceeding that of the comparative samples (320-370° C.). All samples, including the comparative ones, exceeded the thermal decomposition time threshold of 60 minutes (T288), indicating adequate resistance to prolonged high-temperature exposure. Dielectric properties were notably enhanced in the inventive samples, with Sample 3 achieving the lowest dielectric constant (Dk=2.45) and Sample 2 exhibiting the lowest dissipation factor (Df=0.000478), both substantially outperforming the comparative samples (Dk>3.4, Df up to 0.0023). These results collectively demonstrate that the inventive compositions offer a balanced combination of thermal dimensional stability, high thermal resistance, and low dielectric loss, rendering them suitable for demanding high-frequency electronic applications.

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that can vary depending upon the desired properties sought to be obtained. It is noted that, as used in this specification and the appended claims, the singular forms “a,” “an,” and “the,” include plural references unless expressly and unequivocally limited to one referent. As used herein, the term “includes” and its grammatical variants are intended to be non-limiting, such that recitation of items in a list is not to the exclusion of other like items that can be substituted or added to the listed items.

As used herein, the term “comprising” means including elements or steps that are identified following that term, but any such elements or steps are not exhaustive, and an embodiment can include other elements or steps. Although the terms “comprising” and “including” have been used herein to describe various aspects, the terms “consisting essentially of” and “consisting of” can be used in place of “comprising” and “including” to provide for more specific aspects of the disclosure and are also disclosed.

Unless otherwise specified, all technical and scientific terms used herein have the same meanings as commonly understood by one of skill in the art to which the disclosed disclosure belongs. The recitation of a genus of elements, materials, or other components, from which an individual component or mixture of components can be selected, is intended to include all possible sub-generic combinations of the listed components and mixtures thereof.

The patentable scope is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims. To an extent not inconsistent herewith, all citations referred to herein are hereby incorporated by reference.

1. A laminate comprising:
a) a first metal foil;
b) a first insulating layer disposed on the first metal foil, the first insulating layer having a thickness of 3-20 μm, a Dk of <2.8, and a Df<0.002, the first insulating layer comprises:
(i) 40-70 wt. % of a copolymer of (a) a diisoalkenylarene and (b) a divinylarene as a first dielectric polymer, the copolymer having a mole ratio of (a) to (b) from 15:1 to 1:15;
(ii) 30-60 wt. % of a filler; and
(iii) 0-20 wt. % of another dielectric polymer;
c) a second insulating layer disposed on the first insulating layer, the second insulating layer having a thickness greater than the thickness of first insulating layer of 60-150 μm, a Dk of <5.0 and a Df<0.05, the second insulating layer comprises:
(i) 30-60 wt. % of a glass fiber;
(ii) 0-30 wt. % of a filler; and
(iii) 20-50 wt. % of other dielectric polymer;
wherein the other dielectric polymer is selected from the group consisting of polyphenylene ether, cyclic polyolefins, polydicyclopentadiene, polyesters, styrenic block copolymers, polyolefins, polytetrafluoroethylene, polyetherimide, maleimide resin, cyanate ester resin, epoxy resin, phenolic resin, benzoxazine resin, polyamide resin, polyimide resin, polyphenylene sulfide, polysulfone, polyesterimides, polyether sulfone, polyether ketone, polyurethane, polyether ethersulfones, liquid crystalline polymers, polyacrylates and mixtures thereof;
wherein the first insulating layer is positioned between the first metal foil and the second insulating layer;
wherein the laminate has:
a dielectric constant (Dk) of <5;
a dissipation factor (Df) of <0.01;
wherein all the Dk and the Df are measured at 10 GHz, in accordance with ASTM D2520.

2. The laminate of claim 1, further comprising:
(d) a third insulating layer disposed on the second insulating layer, the third insulating layer having the same composition as the first insulating layer; and
(e) a second metal foil disposed on the third insulating layer;
wherein the second insulating layer is disposed between the first and third insulating layers.

3. The laminate of claim 1, further comprising a second metal foil, wherein the second insulating layer is positioned between the first insulating layer and the second metal foil.

4. The laminate of claim 1, wherein the first insulating layer comprises:
from 40-70 wt. % of the copolymer of (a) a diisoalkenylarene and (b) a divinylarene;
from 30 to 60 wt. % of the filler; and
from 2 to 10 wt. % of another dielectric polymer.

5. The laminate of claim 1, wherein the copolymer of (a) a diisoalkenylarene and (b) a divinylarene has a decomposition temperature of >350° C. according to thermogravimetric analysis at 5 wt. % weight loss measured in accordance with ASTM E1131.

6. The laminate of claim 1, wherein the copolymer of (a) a diisoalkenylarene and (b) a divinylarene has a glass transition temperature (Tg) of >200° C., measured in accordance with ASTM D3418.

7. The laminate of claim 1, wherein the second insulating layer is at least 15% thicker than the first insulating layer.

8. The laminate of claim 1, wherein the first insulating layer has a thickness in the range of 5 to 15 μm.

9. The laminate of claim 1, wherein the first insulating layer has a thickness in the range of 7.5 to 12 μm.

10. The laminate of claim 1, wherein the second insulating layer has a thickness in the range of 70 to 120 μm.

11. The laminate of claim 1, wherein the first insulating layer has a dielectric constant (Dk) of less than 2.5 and a dissipation factor (Df) of less than 0.0015.

12. The laminate of claim 3, further comprises an adhesive layer disposed on one or both sides of the second metal foil.

13. The laminate of claim 1, wherein the divinylarene comprises a combination of m-ethylvinylbenzene and p-ethylvinylbenzene in an amount of <35 wt. %, based on total weight of the divinylarene.

14. The laminate of claim 1, wherein the copolymer of (a) a diisoalkenylarene and (b) a divinylarene comprises:
(a) 30 to 95 wt. % of polymerized diisoalkenylarene;
(b) 5 to 70 wt. % of polymerized divinylarene; and
(c) 0 to 15 wt. % of other polymerizable monomer;
based on the total weight of the copolymer.

15. The laminate of claim 1, wherein the diisoalkenylarene is diisopropenylbenzene comprising >75 wt. % of m-diisopropenylbenzene, based on total weight of diisopropenylbenzene.

16. The laminate of claim 1, wherein the diisoalkenylarene has at least one of:
a moisture content of <150 ppm;
a 4-tert-buylcatechol content of <120 ppm; and
a Hazen (APHA) color of <50 measured in a 10 wt. % solution of diisoalkenylarene in a solvent in accordance with ASTM D1209.

17. The laminate of claim 1, wherein the divinylarene comprises at least one of:
a 4-tert-buylcatechol (p-TBC) content of <1200 ppm;
a moisture content of <130 ppm; and
a naphthalene content of <1000 ppm.

18. The laminate of claim 1, wherein the laminate has a coefficient of thermal expansion (CTE) of <30 ppm/° C., measured using TMA over a range of −50 to 300° C.

19. The laminate of claim 1, wherein the laminate has a heat resistance (T288) of >60 min at 300° C., measured in accordance with IPC TM650.

20. The laminate of claim 1, wherein the laminate has a 90° peel strength to metal of >0.6 N/m, measured in accordance with IPC 650 2.4.19.
